(19) United States
(12) Patent Application Publication
(10) Pub. No.: US 2015/0308181 A1
(43) Pub. Date: Oct. 29, 2015

(54) Hollow Profile Member for Windows or Doors

(71) Applicant: düspohl Maschinenbau GmbH, Schloß Holte-Stukenbrock (DE)

(72) Inventor: Uwe Wagner, Gütersloh (DE)

(21) Appl. No.: 14/648,164

(22) PCT Filed: Jan. 14, 2014
(86) PCT No.: PCT/EP2014/050521

§ 371 Date: May 28, 2015

(30) Foreign Application Priority Data
Jan. 21, 2013 (DE) 10 2013 100 588.8

(51) Int. Cl. E06B 3/22; B29C 65/00; E06B 3/30

(52) U.S. Cl. CPC E06B 3/22; E06B 3/30; B29C 66/7422; B29L 2031/005

(57) ABSTRACT

A hollow profile member made of plastics, especially for windows or doors, in which at least a part of an outer surface (20, 22) of the hollow profile member (10) is coated with a metal sheet (18).

The invention relates to a hollow profile member that is made of plastic, especially for windows or doors.

For windows and doors, profile members have become known which are made of wood, metal or plastics and each of which have their specific advantages and disadvantages. Further, hollow profile members have become known which are made of plastics but are internally reinforced by a core profile made of metal. Likewise, metal profiles have become known which have a synthetic resin powder coating on their surface.

It is an object of the invention to provide a hollow profile member that is mainly made of plastics and can be manufactured at low costs and has a high-grade surface as well as a high mechanical stiffness.

According to the invention, this object is achieved by the feature that the hollow profile member is coated with a sheet metal at least on a part of its external surface.

The metal sheet coating improves the optical appearance of the surface of the profile, wherein the surface of the sheet metal may self be finished, e.g. varnished or anodized. Moreover, the metal sheet coating makes the surface of the profile less vulnerable to whether conditions and ultraviolet radiation. In addition, the sheet metal coating permits an additional reinforcement of the profile.

It is a particular advantage of the invention that a relatively low-cost plastic material, especially a recycling plastics, may be used for the core profile, without compromising the appearance of the profile as a whole.

It will be understood that the term “plastic”, as used herein, shall encompass all kinds of material that comprise synthetic resin as an essential component, including composite plastics that contain additives such wood granules or fibres embedded in a resin matrix.

Useful details of the invention are indicated in the dependent claims.

The sheet metal may preferably be a sheet of aluminium or an aluminium alloy. The thickness of the sheet metal may for example be between 0.1 and 1 mm and may preferably be in the order or magnitude of 0.25 mm.

The bending stiffness of the profile is increased by the coating, in particular when two non-parallel surface areas of the plastic profile are coated with a continuous sheet metal.

Preferably, the plastic profile has a core made of a recycling plastics, and an outer plastics layer made of a higher grade plastics such as polyethylene. This plastics composite material may for example be manufactured by co-extrusion.

For coating the profile, it is possible to use a coating apparatus of the type that is used in a similar form for coating profiles with other decorative materials such as paper or plastic films, though with the difference that the rollers which serve for rolling the decorative material onto the profile must be capable of exerting higher pressing forces in view of the larger restoring forces of the metal sheet.

Possibly, it may be necessary to pre-treat the plastic profile in a suitable manner, e.g. by plasma or corona treatment or by applying a primer, before it is coated with the metal sheet. Then, the sheet metal may be applied for example by means of a hot-melt adhesive such as a PUR hot-melt adhesive. Then, it may be useful if the metal sheet is preheated before the adhesive is applied. The bonding process should be performed in an atmosphere with a sufficiently high humidity. For this reason, it may be useful if the air humidity is controlled and adjusted suitably, if necessary, by blowing water vapour into the coating zone.

An embodiment example of the invention will now be explained in conjunction with the drawings, wherein:

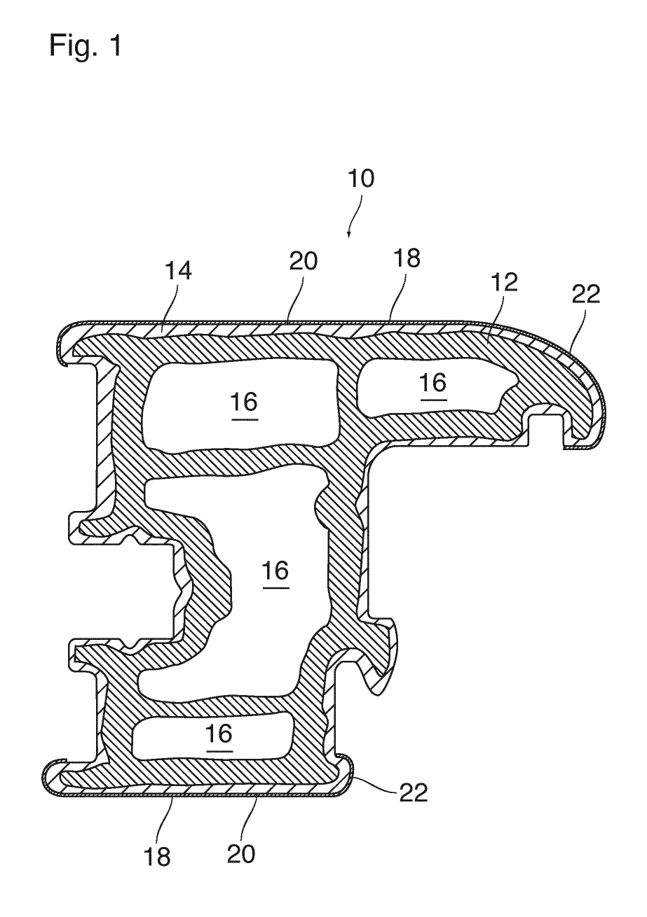

FIG. 1 is a sectional view of a hollow profile member according to the invention; and

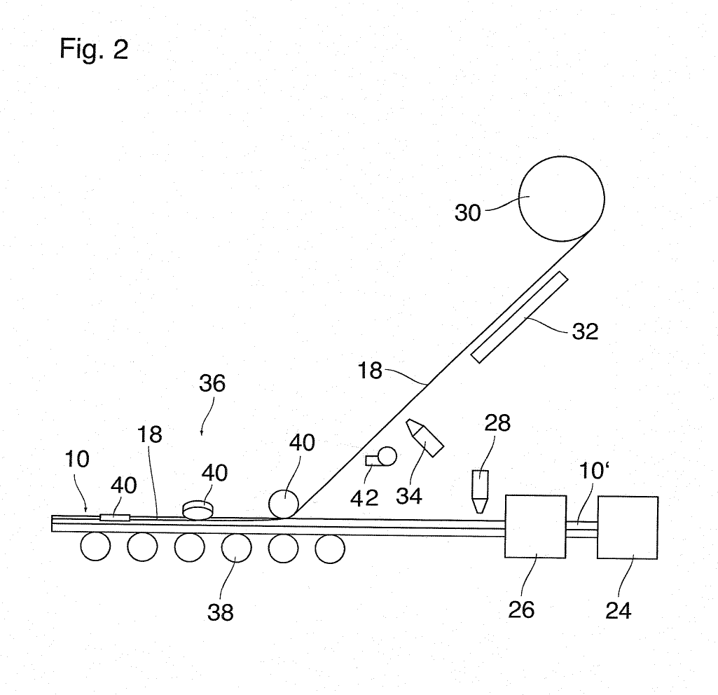

FIG. 2 is a schematic view of a plant for manufacturing the hollow profile according to the invention.

FIG. 1 shows a hollow profile member 10, e.g. a window profile, that has a core 12 made of a recycling plastics and an outer layer 14 made of a higher-grade plastics such as polyethylene. In the example shown, the core 12 has four hollow chambers 16 the walls of which have a relatively irregular shape, due to the properties of the recycling plastics. The outer layer 14 is formed together with the core 12 in a co-extrusion process and gives the hollow profile member 10 a smooth and uniform outer surface.

In the example shown, those areas of the window profile which will be visible after the window has been glazed and installed, have an additional coating made of a metal sheet 18 (aluminium) with a thickness of 0.25 mm. In the example shown, two coating areas are provided, one of which will be located inside of the building and the other of which will be located outside of the building once the window has been installed.

Each of the two coating areas have at least one curved surface area 22 in addition to a flat surface area 20, so that the coating extends over at least two non-parallel surface areas of the plastic profile. Since, consequently, each of the aluminium sheets will itself have a curved or angled profile shape, a particular stiffening effect is achieved.

A method of manufacturing the hollow profile member 10 according to the invention will now be explained with reference to FIG. 2. By means of an extruder 24, a composite profile 10′ that is composed of the core 12 and the outer layer 14 is formed in a co-extrusion process. In the example shown, the composite profile 10′ is passed through a cooling zone 26 as an endless string. When the plastic material of the composite profile 10′ has cured completely, the surface of the outer layer 14 is pre-treated, e.g. in a plasma pre-treatment section 28. Meanwhile, the metal sheet 18 is withdrawn from a coil 30 as an endless web, is heated in a pre-heating station 32 and, then, a hot melt adhesive, e.g. a PUR adhesive, is applied in an adhesive application station 34. Then, in a coating zone 36 in which the composite profile 10′ is supported on transport rollers 38, the metal sheet 18 with the adhesive applied thereto is successively rolled onto the surface of the profile with a plurality of pressure rollers 40 which have different shapes and different orientations, whereby the sheet metal is deformed such that it matches the curvatures of the surface of the profile so as to finally form the coating. FIG. 2 shows only the coating on the top side. The coating on the bottom side, which has been shown in FIG. 1, can be applied analogously.

In a modified embodiment of the manufacturing process described above, it is also possible that the composite profile 10′, after extrusion, is at first divided into rods of suitable length which will be stored temporarily and will then be coated with the sheet metal 18 in a later step.

Depending upon the type of adhesive that is being used, it may be preferable to apply a primer onto the surface of the composite profile 10′ downstream of the pre-treatment section 28 or as a substitute of the plasma pre-treatment. In case of a PUR hot-melt adhesive, the air in the coating zone 36 should have a sufficient humidity because the air humidity promotes the curing of the adhesive. If the natural air humidity is not sufficient, a blower 40 may be used for additionally blowing-in a water vapour.

What is claimed is:

1. A hollow profile member for windows or doors, comprising:
a hollow profile body made of a plastic material the profile body having an outer surface, and
a metal sheet which coats at least a part of the outer surface of the hollow profile body.

2. The hollow profile member according to claim 1, wherein the profile body includes at least two non-parallel surface areas and the metal sheet includes a continuous metal sheet which coats the at least two non-parallel surface areas.

3. The hollow profile member according to claim 1, wherein the metal sheet is a sheet made of one of:
aluminium and
an aluminium alloy.

4. The hollow profile member according to claim 1, wherein at least a major part of the plastic material of the hollow profile member is a recycling plastic material.

5. The hollow profile member according to claim 1, wherein the profile body includes a core made of a first plastic material and an outer layer forming an outer surface of the profile body and being made of a higher-grade second plastic material.

6. The hollow profile member according to claim 5, wherein the core and the outer layer are formed by a co-extruded composite profile.

7. A method of manufacturing a hollow profile member according to claim 1, comprising the step of:
coating the profile body of plastic material in a continuous process with the metal sheet that is withdrawn as an endless web from a coil.

8. The method according to claim 7, wherein the step of coating includes the step of bonding the metal sheet to the plastic profile body with a hot-melt adhesive.

9. The method according to claim 8, further comprising the step of pre-heating the metal sheet before coating.

10. The method according to claim 1, further comprising the step of controlling a humidity content of an atmosphere in a coating zone.
